(19) United States
(12) Patent Application Publication
(10) Pub. No.: US 2019/0270272 A1
(43) Pub. Date: Sep. 5, 2019

(54) COMPOSITE CONSTRUCTION MATERIAL

(71) Applicant: POLYGLASS S.p.A., Ponte di Piave (IT)

(72) Inventors: Louis Grube, Coral Springs, FL (US); Natalino Zanchetta, Boca Raton, FL (US)

(73) Assignee: POLYGLASS S.p.A., Ponte di Piave (IT)

(21) Appl. No.: 16/419,120

(22) Filed: May 22, 2019

Related U.S. Application Data
(62) Division of application No. 15/174,240, filed on Jun. 6, 2016, now abandoned.

(51) Int. Cl. B32B 5/02; E04D 5/10

(52) U.S. Cl. CPC B32B 5/02; E04D 5/10; B32B 2419/06; B32B 2309/105; B32B 2307/718; E04D 5/12; B32B 2395/00; B32B 2307/54; B32B 2307/73; B32B 2323/04; B32B 2323/10; B32B 2305/18

(57) ABSTRACT

A multifunctional composition uses a unique back surfacing that is a parting agent for improved protection during storage and transportation, that protects the exposed surface from asphaltic staining and transfer of the back surfacing to the exposed or top surface of the material, that can be used on all types of asphaltic compounds including plastic and rubber modified bitumen and that can be applied using convention application techniques like heat welding, hot mopping molten asphalt or the like and cold applied mastics and cements or the like.

### CROSS-REFERENCE TO RELATED APPLICATIONS

The present application claims priority to and is a divisional of U.S. patent application Ser. No. 15/174,240 filed Jun. 6, 2016 and entitled “COMPOSITE CONSTRUCTION MATERIAL” which is hereby incorporated herein by reference in entirety for all purposes.

The present application also claims priority to U.S. Provisional Patent Application Ser. No. 62/170,846 filed Jun. 4, 2015 and entitled “MULTIFACETED COMPOSITE BUILDING CONSTRUCTION MATERIAL” which is hereby incorporated herein by reference in entirety for all purposes.

### FIELD

The present invention relates to building construction materials for forming an exterior building surface, and more particularly, to roofing, siding, and the like, which form a weather barrier allowing the construction of a weather-controlled building envelope and which shields the interior of the building from the intrusion of air, precipitation, and solar radiation.

### BACKGROUND

Roofs perform an important function of protecting buildings from weather, such as precipitation and solar radiation. In recent years, the function of roofing as a shield against solar radiation has increased in significance as an area that can be improved to lower energy consumption in maintaining comfortable temperatures in buildings. The color of a roof has a significant impact on the absorbance/reflection of solar energy and therefore has a significant effect on the amount of energy required to heat/cool a building having that color roof.

In hot climates, roofs with greater reflectivity can reduce energy costs related to air conditioning (cooling). In recognition of this effect, government entities have passed laws and regulations pertaining to the color/reflectivity of roofs and established incentives and criteria for selecting roofing materials that result in lowered energy demand. Ratings exist (Energy Star®) to characterize roofing light/heat reflectivity relative to that irradiating a given surface—as a fraction or percentage. For example, the United States Environmental Protection Agency's Energy Star Reflective Roof Program calls for low slope roofs (2:12 or less) to have an initial minimum solar reflectance of 0.65 and an aged three-year reflectance of 0.50. For steep-slope (greater than 2:12) roofs, minimum initial solar reflectance is 0.25, aged three-year reflectance greater than 0.15. As of 2009, ENERGY STAR allows products to qualify for ENERGY STAR certification using the CRRC Color Family Groups in accordance with the CRRC Product Rating Program Manual CRRC-1. Reflectance requirements vary depending upon the standard making body, some requiring greater initial reflectance of low slope roofs, e.g., 0.70 (ASHRAE) or 0.72 (Chicago).

Given a source of reflective granules, it is an objective of roofing manufacturers to achieve maximum coverage of the dark-colored bituminous membrane with the granules and to avoid spaces between the granules through which the dark membrane can be seen and which decreases reflectivity and increases solar radiation absorption.

The reflectivity of a given granule surface may be increased by applying a reflective coating to the granule surface of a finished roofing membrane, e.g., by applying a paint to the granular surface. This may be conducted after the roof has been installed on a building, or may be applied to the roofing membrane during manufacture in the factory. If applied during manufacturing it is important to protect the reflective surface to avoid staining or asphalt “strike through. The top or exposed surface may have a primer paint applied followed by a top color layer to help reduce asphalt staining from the asphaltic material below and where the granules are embedded but a suitable back surface must be used to avoid asphaltic staining from occurring during storage, transportation or the like.

The back surfacing facilitates bonding during application and can also function as a parting agent to prevent sticking of the material during manufacturing, storage and transportation. Multiple layers of paint represent added costs so it is important that the material remain as white as possible when applied and be protected from staining during manufacturing, storage, transportation and the like.

Many of the attributes of roofing are shared with materials used to construct the sides of a building, e.g., the ability to waterproof, exclude precipitation and reflect or otherwise diminish unwanted solar radiation. In the following disclosure, roofing material is referred to in several exemplary embodiments of the present disclosure; however, the teachings of the present disclosure could be advantageously employed in forming materials for construction of areas of a building other than the roof, e.g., the sides or siding of the building.

One common type of roofing that is popular today is Bituminous (asphaltic) roofing, which is aesthetically pleasing, economical and effective, as well as relatively simple to install. Bituminous roofing membranes have been known and used for many years for forming waterproof roofs for buildings, both residential and commercial. Typically these asphaltic roofs commonly referred to as shingles, Built Up Roofing (BUR) Cap Sheets or Cap Sheets or the like are finished on the back with talc, sand, mica, small granules or the like and on the top or exposed surface they are finished with granules of various colors or the like, or films like aluminum, polyvinylidene fluoride (PVDF) or the like to help protect the material, impart solar reflectivity and add an aesthetically pleasing look to the roofing or siding structure. At times the granules used in asphaltic based materials are white or coated with a white acrylic coating or the like to improve solar reflectivity.

On the back of these asphaltic materials sand, talc, mica or the like are used as a parting agent to prevent the material from sticking to rollers on the machine during manufacturing, to help prevent staining or asphalt oil transfer from the back of the material to the surface of the material particularly if the material is cut in pieces and stacked together during packaging or cut and wound into rolls and from sticking together during storage and transportation.

The sand, talc, mica or the like that is used as a parting agent on the back of these materials can transfer to the surface of the material during storage and transportation and can be a problem when granules, particularly light colored or white granules or similar white materials are used on the surface of the product particularly if these granules are coated during manufacturing with a white acrylic coating or the like or a light colored or white film is used on the surface of the material to impart high solar reflectivity. The transfer of the parting agent to the surface can reduce the solar reflectivity of the material.

Oils from the asphalt can migrate from the back of the sheet to the surface of the material causing staining. This can be a problem when granules, particularly light colored or white granules or similar white materials are used on the surface of the product particularly if these granules are coated during manufacturing with a white acrylic coating or the like or a light colored or white film is used on the surface of the material to impart high solar reflectivity. The oil transfer and staining from the asphalt is unsightly, can ruin the aesthetic appeal and reduce the solar reflectivity of the material. This staining is well known in the industry.

Larger particle size parting agents or applying the parting agent in abundant amounts can be used to help alleviate the oil transfer or staining issue. Using an abundant amount of parting agent increases the likelihood that the parting agent itself will transfer to the surface of the material causing an issue and more importantly, an abundant amount of parting agent can prevent the material from bonding together during application. When the material is stored in a hot environment, these parting agents can get absorbed into the material and staining from asphaltic oils can still occur.

The granules commonly used on the surface of the material are not flat but have dimension. These granules are partially embedded into the top surface of the asphaltic material and because of the granule shape they come in contact with the back of the material when cut and wound into rolls or cut into pieces and stacked packaged together. Where the granules, film or the like come into contact with the asphaltic material or with the parting agent used on the back of the material, asphalt staining can occur.

Typically the asphaltic based materials have been installed using adhesives whether factory applied or field applied. Field applied adhesives typically consist of molten asphalt or cold applied mastics and cements or the like. The asphalt is heated to become molten and acts as an adhesive when it is hot and when cool forms a strong bond where applied. Cold applied mastics and cements usually incorporate a solvent in them to make them less viscous and easier to apply. The solvent can be mineral spirits, toluene, xylene or the like that evaporates after application and when the solvent is dissipated, the bond becomes strong.

These asphaltic materials are finished on the back with sand, talc, mica or the like to ensure a good bond with the field applied adhesives. The molten asphalt or cold applied adhesives can come into direct contact with portions of the asphaltic surface between the areas of these parting agents on the back of the membrane. The molten asphalt and or cold applied adhesive bites into the asphaltic material, grips it and forms strong bonds where applied.

There is a need for a better parting agent for these Bituminous materials that helps facilitate the bonding during application, stays on the back of the asphaltic material, does not transfer to the surface of that material and can prevent asphaltic light ends and oil transfer and staining of the surface of the material, particularly when the surface is light colored or a white surface is used to impart high solar reflectivity, that maintains the aesthetically pleasing appearance and preserve the solar reflectivity of the material.

Modified bituminous roofing membranes are classified into two major groups, plastic modified and rubber modified. These modified bitumen products are formed around a fabric sheet made from polyester, fiberglass or the like. The fabric sheet is coated with bitumen (asphalt) or modified bitumen compound. The modifiers change the properties of the asphalt to increase its utility as a roofing membrane, e.g., to make it more elastic, have greater flexibility at low temperatures and greater heat resistance at high temperatures to prevent softening/flow and deformation from mechanical forces, such as those associated with maintenance personnel walking on the roofing membrane. A roofing membrane may be formed of a laminate of a plurality of types of modified asphalt, e.g., a layer of a first type may be formed on the bottom surface that has an increased adhesive grip on the roofing underlayment and a different layer may be used on the upper surface that has enhanced weather resistance, etc.

The plastic modified bitumen products are modified with one or more modifiers such as Atactic Polypropylene (APP), Amorphous Poly Alpha Olefin (APAO), Thermoplastic Polyolefin (TPO), low density polyethylene (LDPE), high density polypropylene (HDPE) or the like. Plastic modified bitumen materials are preferred over other forms of asphaltic materials due to the improved weathering resistance, improved resistance to oils, fat, acid and the like, better hardness, higher softening point, lower glass transition and ease of application. Typically plastic modified bitumen membranes are finished on the top surface with granules or the like of various colors to help protect the material and add an aesthetically pleasing look to the roofing or siding structure.

These granules are often light colored, white or coated with a white acrylic coating or the like to increase the solar reflectivity of the material. Aluminum films, PVDF films or the like are commonly used the plastic modified bitumen compound particularly if a multilayer composition is employed to prevent these films from delaminating during the service life of the material.

These plastic modified bitumen materials can be finished on the back with sand, talc, mica or the like or more commonly with a plastic film made of polypropylene, polyethylene, polyester or the like and is used as a parting agent to prevent the material from sticking to rollers on the machine during manufacturing to help prevent staining or asphalt oil transfer from the back of the material to the surface of the material particularly if the material is cut in pieces and stacked together during packaging or cut and wound into rolls and from sticking together during storage and transportation.

Typically the plastic modified bitumen based materials have been installed using a propane torch, hot air or the like where a heat source is used to melt the plastic modified bitumen material to adhere and to form welded seams for good attachment and bond strength. If a plastic film is used on the back of the material, the plastic film is melted along with the material during installation. These membranes are not typically applied with molten asphalt or cold applied mastics as the plastic nature of these materials are more difficult to bond and maintain the bond strength over the life of the material when installed in this way. Plastic modified bitumen compound can have light ends exude from the polymers and or asphalt that could stain the surface of the material if the plastic film is not used as a back surfacing. The asphaltic light ends and oil transfer and staining of the surface of the material, particularly when the surface is light colored or a white surface is used to impart high solar reflectivity, can diminish the aesthetically pleasing appearance and preserve the solar reflectivity of the material.

If molten asphalt is used to adhere to the plastic modified bitumen material, these light ends and oils can come to the interface between the asphalt and plastic modified bitumen causing an incompatibility between these two materials that can cause bond failure over time. Cold applied mastics and cements are not generally used with plastic modified bitumen materials because the solvent cannot bite into the plastic nature of the material and because it is plastic in nature, the solvent cannot easily dissipate through the material. This causes the solvent to be retained in the cold applied adhesive reducing bond strength. Once the solvent is trapped between the material and roofing deck or the like it cannot readily pass through the plastic modified material, often this solvent will dissipate through the substructure and into homes and buildings causing an unpleasant odor to the occupants and at times an unsafe condition if the structure is not properly ventilated.

The plastic film on the back of the plastic modified bitumen material works well as a parting agent and can prevent asphaltic oils and light ends from the asphalt and polymers from staining and transferring to the surface of the plastic modified bitumen material but the film cannot be used if the material is to be adhered with molten asphalt or cold applied cements and adhesives. In this case sand, talc, mica or the like is used as a parting agent and these materials as mentioned previously can transfer to the surface, the oils from the asphaltic compound can stain the surface and ruin the aesthetically pleasing look and if a white highly reflective surface is used, this staining can reduce the solar reflectivity of the material.

There needs to be a parting agent or back surfacing for plastic modified bitumen membranes that can prevent the transfer of the parting agent to the surface of the material, can prevent staining similar to a plastic film, that allows for solvents to readily vent out and anchor the material so that cold applied adhesives and cements and molten asphalt can be used to attach plastic modified bitumen materials together.

The rubber modified bitumen products are modified with one or more modifiers such as Styrene-Butadiene-Styrene (SBS), Styrene-Ethylene-Butadiene-Styrene (SEBS), or synthetic rubber or the like. Sometimes a small amount of plastic material like Low Density Polyethylene (LDPE) or the like is added to the rubber. Typically these rubber modified roofs are finished on the surface granules of various colors or the like, or films like aluminum, polyvinylidene fluoride (PVDF) or the like to help protect the material, impart solar reflectivity and add an aesthetically pleasing look to the roofing or siding structure. The granules used in the rubber modified materials are often light colored or white or coated with a white acrylic coating or the like to improve solar reflectivity.

On the back of these rubber modified bitumen materials sand, talc, mica or the like are used as a parting agent to prevent the material from sticking to rollers on the machine during manufacturing, to help prevent staining or asphalt oil transfer from the back of the material to the surface of the material particularly if the material is cut in pieces and stacked together during packaging or cut and wound into rolls and from sticking together during storage and transportation. When parting agents like sand, talc, mica or the like are used issues with the parting agent transferring to the surface of the material can occur, asphaltic staining and oil transfer can be a problem particularly when light colored or white granules or similar white materials like PVDF film is used on the surface of the product particularly if these granules are coated during manufacturing with a white acrylic coating or the like.

The granules commonly used on the surface of the rubber modified bitumen material are not flat but have dimension. These granules are partially embedded into the top surface of the asphaltic material and because of the granule shape they come in contact with the back of the material when cut and wound into rolls or cut into pieces and packaged together. Where the granules, film or the like come into contact with the asphaltic material or with the parting agent used on the back of the material, asphalt staining can occur.

Rubber modified bitumen materials finished with sand, mica, talc or the like on the back of the material are commonly installed using molten asphalt or cold applied mastics and cements as the asphalt and rubber polymer readily absorbs the solvent and helps it to dissipate.

Molten asphalt can be used due to the lower softening point of rubber modified bitumen materials that are in the range of standard asphaltic materials and there is good compatibility with molten asphalt used to adhere to the rubber modified bitumen materials. An issue still arises if too much sand, mica, talc or the like are added to the back of rubber modified bitumen materials. Using an abundant amount of parting agent increases the likelihood that the parting agent itself will transfer to the surface of the material causing an issue and more importantly, an abundant amount of parting agent can prevent the material from bonding together during application. When the material is stored in a hot environment, these parting agents can get absorbed into the material and staining from asphaltic oils can still occur.

There is a need for a better parting agent that stays on the back of the material that helps with the bonding, does not transfer to the surface of that material that can also prevent asphaltic light ends and oil transfer particularly when the surface is light colored or white or coated with a white film or acrylic coating or the like to maintain the aesthetic surface appearance and preserve the solar reflectivity of the material.

Rubber modified bitumen products can also be finished on the back of the material with plastic film or the like similar to plastic modified bitumen products and can be installed using the same heat welding techniques as those employed for plastic modified bitumen materials. If the rubber modified bitumen material has a film on the back than it cannot be installed with molten asphalt or cold applied adhesives and cements or the like because the solvent will not dissipate readily and bond strength will take a long time to achieve. Also, since the solvent is trapped between the material and roofing deck or the like it cannot readily pass through the plastic film, often this solvent will dissipate through the substructure and into homes and buildings causing an unpleasant odor to the occupants and at times an unsafe condition if the structure is not properly ventilated. The plastic film on the back of the rubber modified bitumen material works well as a parting agent and can prevent asphaltic oils and light ends from the asphalt and polymers from staining the surface of the rubber modified bitumen material but the film cannot be used if the material is to be adhered with molten asphalt or cold applied cements and adhesives.

Given the limitations of known methods and materials for forming roofing or siding materials and or with forming roofing or siding materials with high reflectivity, durability and weather resistance, improved methods and materials remain desirable, e.g., methods and materials for using a single material as a back surfacing for asphaltic materials, plastic modified bitumen materials and rubber modified bitumen materials that can be used to attach the material when molten asphalt, cold applied mastics and cements are used and when heat welding that can also protect a highly reflective surface from parting agent transfer, oil staining or oil transfer to the surface, which is conveniently and safely implemented in the manufacturing process.

This desired back surfacing or parting agent must prevent staining, must be easily bonded to the back of the material, must be strong to maintain bond strengths, must allow cold applied mastics and cements or the like to penetrate it and allow the solvents from the mastics and cements to readily vent out for good bond strength, safety and it must help anchor the material to the next layer, roof or siding, it must readily melt during heat welding application and it must allow molten asphalt to penetrate it and come in contact with the back of the material to better anchor the material and it must be usable for all types of asphaltic materials including plastic and rubber modified bitumen materials.

If this desired parting agent or back surfacing can be found, manufactures can reduce the number of products to be sold and reduce transportation costs and warehouse space for themselves and for customers and or distributors of their products since the desired parting agent can be used to replace products made with sand, mica, talc or the like and can also replace the plastic film. There would be no need to make materials with two different parting agents for different application methods. For example, there would be no need for a material with sand, mica or talc or the like on the back surface and the same type of material finished with a plastic film on the back. These two materials could now be one in the same. That material finished with the desired back surfacing or parting agent can be applied by different application methods including heat welding, cold applied adhesives and mastics and with molten asphalt or the like.

The fabric is usually applied in line or adjacent to the manufacturing line by use of a 90 degree turn bar. It is aligned to the back of the membrane manually or by electronic or laser sensing devices to keep the fabric from overhanging the edge of the membrane significantly. Overhang is acceptable in some cases and could be desired depending on the application method. Also using fabric that is wider or narrower than the membrane and using an alternate surfacing is in the realm of this patent. As warranted for a particular application the fabric can be designed to cover only a portion of the back of the membrane and using a standard parting agent, film, pressure sensitive adhesive, asphalt or modified asphaltic compound in the portion not covered with the fabric. It may also be advantageous that during the manufacturing process that fabric could be applied on the selvage edge particularly on granulated products to ease manufacturing of the product. This is particularly true if the granules are subsequently treated or have previously been treated with a highly reflective coating of latex, urethane, silicone and hybrid coatings or the like and the coating is not complete dry when applying the parting agent at the selvage edge. This would eliminate the need for the normal parting agent used on the selvage edges such as sand, talc, mica or other known parting agents, these parting agents are intended to prevent transferring to the freshly applied highly reflective or even a clear or non-highly reflective coating during application of the parting agent and even after when the product turns on the manufacturing machine. These parting agents could fall off and stick to the coating causing a diminishing of the product's aesthetic appearance and or reduce the reflectivity of the membrane that could reduce the effectiveness of the coating.

### SUMMARY

The disclosed subject matter overcomes the disadvantages and shortcomings of the prior art by providing a multifaceted building or construction material that is easy to manufacture, that can protect the top or exposed surface of that material from asphaltic stains and from the parting agent transferring to the top surface particularly when that top or exposed surface is a highly reflective surface. In addition this construction material can be used with conventional application methods such as: heat welding, molten asphalt, cold applied mastics and cements or the like, on all asphaltic materials including plastic modified bitumen materials, rubber modified bitumen materials or combinations thereof or the like, And this construction material can act as a parting agent during manufacturing, storage and transportation.

### BRIEF DESCRIPTION OF THE DRAWINGS

For a more complete understanding of the present invention, reference is made to the following detailed description of exemplary embodiments considered in conjunction with the accompanying drawings.

FIG. 1 shows a roofing membrane 10 in accordance with an embodiment of the present disclosure.

FIG. 2 is a perspective, partially exploded cross view of a modified bituminous, laminated roofing membrane 10 in accordance with an exemplary embodiment of the present disclosure. For ease of visualization, the layers 12, 14, 20 are shown spaced apart.

FIG. 3 is a partially exploded cross view of a modified bituminous, laminated roofing membrane in accordance with another exemplary embodiment of the present disclosure with bottom compound layer 14 and light weight fabric layer 20 laminated together. Layer 20 is shown to be embedded about half way into bottom compound layer 14.

FIG. 4 is a perspective, partially exploded cross view of a modified bituminous, laminated roofing membrane 10 in accordance with an exemplary embodiment of the present disclosure. This embodiment of the roofing membrane 10 does not include an inner substrate or carrier mat 12.

FIG. 5 is a perspective, partially exploded cross view of a modified bituminous, laminated roofing membrane 10 in accordance with an exemplary embodiment of the present disclosure. This embodiment of the roofing membrane 10 does not include an inner substrate or carrier mat 12. This embodiment does include a highly reflective optional layer 34.

FIG. 6 is a perspective, partially exploded cross view of a modified bituminous, laminated roofing membrane 10 in accordance with an exemplary embodiment of the present disclosure. This embodiment of the roofing membrane 10 does not include an inner substrate or carrier mat 12. In this embodiment the top compound layer 16 shows a surfacing that can be made of a film, cross laminated film, aluminum, tri-coated aluminum film, PVDF film or the like or another surfacing such as acrylic, silicone or urethane coating.

### DETAILED DESCRIPTION OF EXEMPLARY EMBODIMENTS

Surprisingly a simple solution to the problems has been found in using a light basis weight fabric (20) that can replace the sand, mica, talc or the like and the plastic film or the like. This light weight basis fabric prevents staining of asphalt from the back of the material to the upper or exposed layer of the material and that fabric can prevent sticking of the material to the rollers during manufacturing, can remain in place during storage and transportation and during the application of the material. The material with the light basis weight fabric can be applied using conventional techniques like heat welding, hot mopping or molten asphalt application or the like and be adhered using cold applied mastics and cements or the like on all types of asphaltic materials and all types of modified bitumen membranes including plastic and rubber modified membranes and combinations thereof of asphaltic and modified bitumen materials or the like.

The preferred fabric (20) is a light weight fabric made of polypropylene, polyethylene or combination thereof. The more preferred fabric is a combination of polypropylene and polyethylene and an even more preferred fabric is made of polypropylene. The fabric is applied during the manufacturing process when the asphaltic or bitumen material is still hot so that the fabric can be partially embedded into the back of the material for good bond strength before and after application.

The fabric is usually purchased in roll form but this is optional. During manufacturing the fabric is usually adhered to the back of the material while it is still hot. It can be applied right after the molten compound is applied to the material or in a secondary step by reheating the back of the material and applying it then. An alternate way of adhering the fabric can be used, such as an adhesive to bond it to the back of the material for example. Any method of adhering the fabric to the material will be considered part of this patent.

The fabric is usually applied with an optional bow roller or similar device to help smooth out wrinkles in the fabric and make it a smooth layer on the back of the material. Making the fabric completely smooth is not necessary for the invention to work. Sometimes an optional pressure point is used like a nip roll or squeegee or the like or an S-wrap or the like that can help embed the fabric into the hot material but this is optional as other means can be employ or adhere the fabric during the manufacturing process.

The fabric usually does not melt during the manufacturing process but it can if desired. If desired, the fabric can be melted completely or partially during the manufacturing process as long as when the fabric is cooled a portion of the fabric remains on the outermost surface of the material so that it can act as a parting agent.

If melting or partially melting the fabric is desired one can envision multiple ways of melting the fabric like applying it to very hot compound or adding torches or the like or infrared heaters or the like or similar means of heating so that the bond strength between the fabric and the material can be improved. Melting or partially melting the fabric is not necessary for the invention to work.

The basis weight and thickness of the disclosed fabric is very important. If the fabric is too thin, asphaltic compound will bleed through during the manufacturing process and staining can occur or be transferred to the top or exposed surface of the material during storage or transportation. If the fabric is too thick it cannot be embedded to the proper depth in the compound and the fabric can debond after application or it will not melt readily when heat welding techniques are used.

If the fabric is too thick the bond strength is reduced if the molten asphalt or cold applied cements and mastics used may not penetrate the fabric to the back of the material. This penetration is needed so that a good bond is achieved. If the fabric is not penetrated by the molten asphalt or cold applied mastics the fabric could tear or delaminate after application and the roofing or siding material may not stay adhered.

There is a fine line as to the thickness of the fabric and the basis weight of the fabric so that it can protect the top surface of the material and still be applied by the three conventional application methods mentioned previously.

The preferred basis weight of this fabric is 5-40 g/m², more preferred 10-30 g/m2, and even more preferred is a 15-20 g/m² polypropylene fabric that has been treated to be hydrophobic. The polypropylene, polyethylene or combination thereof fabric has a preferred thickness of 0.1-0.5 mm thick, more preferred 0.15-0.30 mm thick, and even more preferred 0.17-0.20 mm thick.

The fabric must also be strong to work as an interface during application. The tensile strength of the disclosed fabric is important during manufacturing the material as it is applied when the asphaltic compound is hot so that it can embed into the material about half way, not break during manufacturing, and provide good bond strength for the field applied materials to withstand building movement, weather conditions and the like. The fabric has a preferred tensile strength of 20-80 N/50 mm in the machine direction (MD), more preferred 25-60 N/50 mm, and most preferred 30-50 N/50 mm.

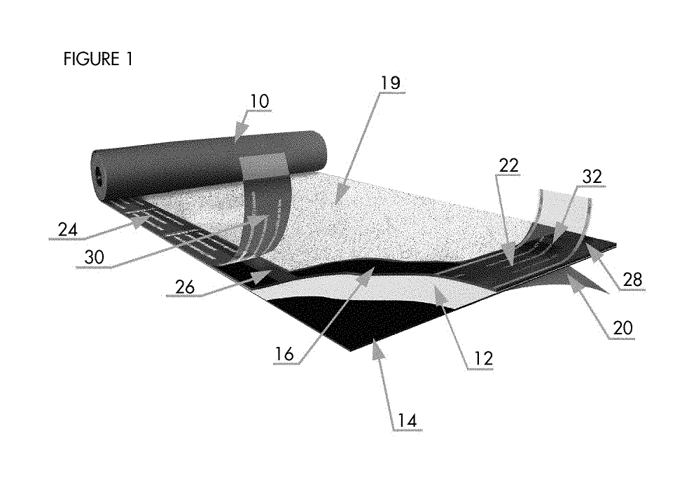

FIG. 1 shows a roofing membrane 10 in accordance with an embodiment of the present disclosure. The roofing membrane 10 has an inner substrate or carrier mat 12 composed of polyester or fiberglass or other similar material from which a roofing substrate or carrier mat 12 may be made. Bottom compound and top compound layers 14, 16, respectively, are made of compounds such as asphaltic or modified bitumen compound, or combinations thereof, are laminated or coated to opposing sides of the substrate or carrier mat 12 in one or more steps. Layer 12 can be impregnated with the asphaltic or modified bitumen compound or the like or combinations thereof in one or more steps. Top compound layer 16 has a plurality of optional granules (18) disposed over the upper surface thereof forming an optional granular surface. Optionally, peripheral edges 22, 24 may be left smooth (without granules) to form a bonding or overlap area where optional beads of adhesive 26, 28 may be applied. Optional layers 30, 32 are release films for optional Layers 26, 28. As noted above, while the membrane 10 is described as a roofing membrane, it could also be used for other applications, such as siding. The asphalt or asphaltic compound can be applied and or impregnate the mat in one, two or even more steps during production.

Bottom layer 20 is a light basis weight fabric made of polypropylene, polyethylene, or combination thereof. The light basis weight fabric should be made from hydrophobic fibers or treated to be hydrophobic to prevent absorption, wicking, or sucking up of liquids or moisture from the air, environment or atmospheres but this is not mandatory for the invention to work. As noted above, while the membrane 10 is described as a roofing membrane, it could also be used for other applications, such as siding.

FIG. 2 shows a roofing membrane 10 in accordance with an embodiment of the present disclosure with the layers 12, 14 and 20 are shown spaced apart. The roofing membrane 10 has an inner sheet or carrier mat 12 composed of polyester or fiberglass or other similar material from which a fabric may be made. Bottom compound and top compound layers 14, 16, respectively, are made of compounds such as asphaltic or modified bitumen compound, or combinations thereof, are laminated to opposing sides of the substrate or carrier mat 12 in one or more steps. Layer 12 can be impregnated with compounds such as asphaltic or modified bitumen compound, or combinations thereof in one or more steps. Bottom layer 20 is a fabric made of polypropylene, polyethylene or combination thereof and acts as the back surface and or parting agent layer. Top layer 16 has a plurality of optional granules 18 disposed over the upper surface thereof forming a granular surface 19. Optional granules 18 can be seen to be partially embedded in top compound Layer 16 that is made of an asphaltic or modified bitumen compound or the like or combinations thereof. As noted above, while the membrane 10 is described as a roofing membrane, it could also be used for other applications, such as siding.

Bottom layer 20 is a light basis weight fabric made of polypropylene, polyethylene or combination thereof is shown to be partially embedded in the asphaltic and or bottom asphaltic compound layer 14.

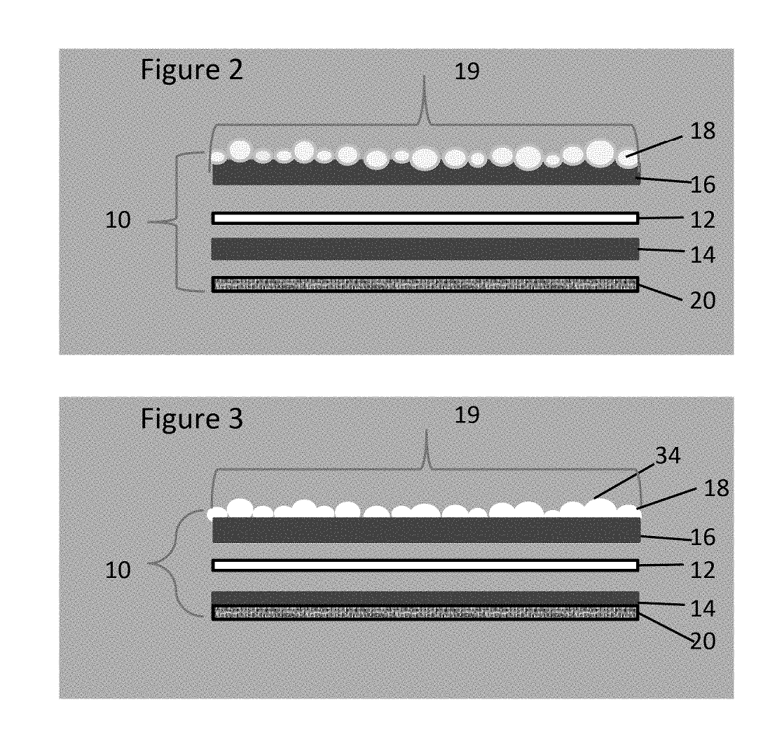

FIG. 3 shows membrane 10, with bottom compound layer 14 and light weight fabric layer 20 laminated together. Layer 20 is shown to be embedded about half way into bottom compound layer 14. Bottom compound and top compound layers 14, 16, respectively, are made of compounds such as asphaltic or modified bitumen compound, or combinations thereof are laminated to opposing sides of the substrate or carrier mat 12 in one or more steps. The roofing membrane 10 has an inner substrate or carrier mat 12 composed of polyester or fiberglass or other similar material from which a roofing substrate or carrier mat may be made. Layer 12 is shown separate for ease of viewing. Layer 12 can be impregnated with compounds such as the asphaltic or modified bitumen compound, or combinations thereof, in one or more steps. Top layer 16 has a plurality of optional granules 18 disposed over the upper surface thereof forming an optional granular surface 19. Optional granules 18 are shown covered with a white acrylic or similar coating forming a highly reflective optional layer 22. As noted above, while the membrane 10 is described as a roofing membrane, it could also be used for other applications, such as siding, walk way pads or a protection course for below grade construction.

Bottom layer 20 is a light basis weight fabric made of polypropylene, polyethylene or combination thereof is shown to be partially embedded in the asphaltic and or bottom asphaltic compound layer 14.

The embodiment shown on FIG. 4 does not include an inner substrate or carrier mat 12. The asphalt or modified asphalt can be coated directly to light weight fabric 20 in one or more steps to form layer 16. Layer 16 is often called the top compound and is made from asphalt and or modified bitumen compound that is laminated or coated to one side of fabric 20. The top compound layer 16 shows a plurality of granules disposed over the upper surface thereof forming an optional granular surface 19. Bottom layer 20 is a light basis weight fabric made of polypropylene, polyethylene or combination thereof is shown to be partially embedded in the asphaltic and or modified bitumen compound layer 16.

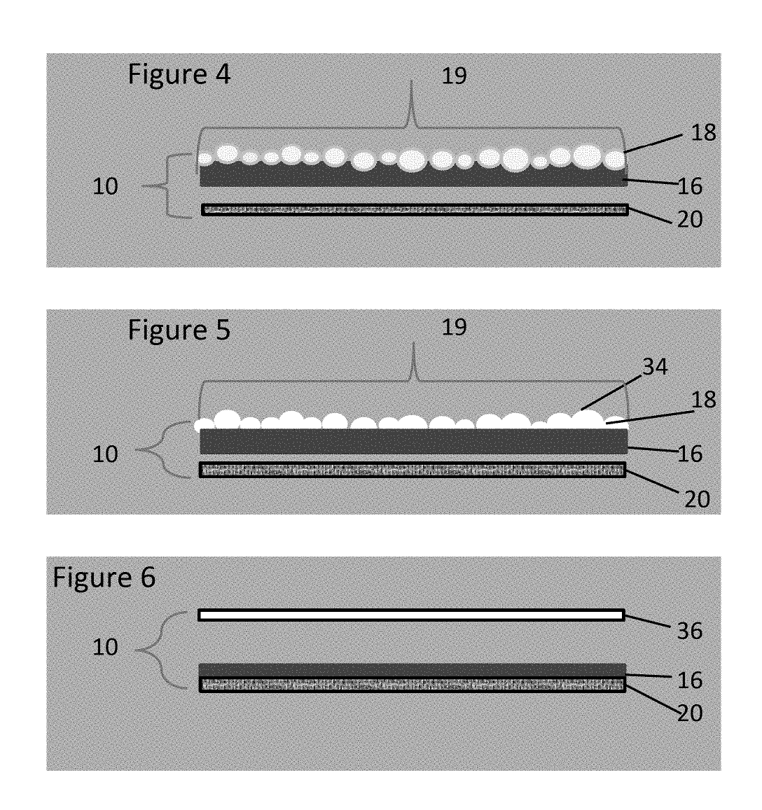

The embodiment shown on FIG. 5 does not include an inner substrate or carrier mat 12. The asphalt or modified asphalt can be coated directly to light weight fabric 20 in one or more steps to form layer 16. Layer 16 is often called the top compound and is made from asphalt and or modified bitumen compound that is laminated or coated to one side of fabric 20. The top compound layer 16 shows a plurality of granules 18 disposed over the upper surface thereof forming an optional granular surface 19 that has been coated with a highly reflective optional layer 34 to make a membrane with a highly reflective top surface. Bottom layer 20 is a light basis weight fabric made of polypropylene, polyethylene or combination thereof is shown to be partially embedded in the asphaltic and or modified bitumen compound layer 16.

The embodiment shown on FIG. 6 does not include an inner substrate or carrier mat 12. The asphalt or modified asphalt can be coated directly to light weight fabric 20 in one or more steps to form layer 16. Layer 16 the top compound is made from asphalt and or modified bitumen compound that is laminated or coated to one side of fabric 20. The top compound layer 16 shows a surfacing that can be made of a film, cross laminated film, aluminum, tri-coated aluminum film, PVDF or similar film, or another surfacing such as acrylic, silicone or urethane coating. Alternately if layer 36 is a film it can be coated or laminated directly with asphaltic or modified bitumen compound to form layer 16 and bottom layer 20 is then laminated to the asphaltic or modified bitumen compound layer 16. Bottom layer 20 is a light basis weight fabric made of polypropylene, polyethylene or combination thereof is shown to be partially embedded in the asphaltic and or modified bitumen compound layer 16.

In one embodiment the material composition comprises:
an upper asphaltic layer;
a lower asphaltic layer;
a carrier mat located in between the upper layer and lower layer;
a bottom surface comprised of at least one fabric which is composed of at least one of the following: polypropylene, polyethylene;
the lower asphaltic layer is partially embedded into the fabric; and
wherein at least a portion of the fabric remains on an outermost surface on the bottom surface of the material composition.
   A process for creating and applying a material composition on a roof comprising:
selecting a material composition comprising:
   an upper asphaltic layer;
   a lower asphaltic layer;
   a carrier mat located in between the upper layer and lower layer;
   a bottom surface comprised of at least one fabric which is composed of at least one of the following: polypropylene, polyethylene;
   the lower asphaltic layer is partially embedded into the fabric; and
   wherein at least a portion of the fabric remains on an outermost surface on the bottom surface of the construction material; and
bonding the portion of the fabric on an outermost surface on the bottom surface of the material composition to a roof.

The above is a detailed description of particular embodiments of the invention. It is recognized that departures from the disclosed embodiments may be made within the scope of the invention and that obvious modifications will occur to a person skilled in the art. Those of skill in the art should, in light of the present disclosure, appreciate that many changes can be made in the specific embodiments which are disclosed herein and still obtain a like or similar result without departing from the spirit and scope of the invention. All of the embodiments disclosed and claimed herein can be made and executed without undue experimentation in light of the present disclosure.

I claim:

1. A process for creating and applying a material composition on a roof comprising:
selecting a material composition comprising:
an upper asphaltic layer;
a lower asphaltic layer;
a carrier mat located in between the upper layer and lower layer;
a bottom surface comprised of at least one fabric which is composed of at least one of the following: polypropylene, polyethylene;
the lower asphaltic layer is partially embedded into the fabric; and
wherein at least a portion of the fabric remains on an outermost surface on the bottom surface of the material composition; and
bonding the portion of the fabric on an outermost surface on the bottom surface of the material composition to a roof.

2. The process according to claim 1 wherein the portion of the fabric on the outermost surface on the bottom surface of the material composition is bonded to the roof using heat welding.

3. The process according to claim 1 wherein the portion of the fabric on the outermost surface on the bottom surface of the material composition is bonded to the roof using hot mopping.

4. The process according to claim 1 wherein the portion of the fabric on the outermost surface on the bottom surface of the material composition is bonded to the roof using molten asphalt.

5. The process according to claim 1 wherein the portion of the fabric on the outermost surface on the bottom surface of the material composition is bonded to the roof using cold applied mastics and cements.

6. The process according to claim 1 wherein the fabric has a basis weight between 5 and 20 g/m², the fabric has a thickness between 0.1 and 0.5 mm, and the fabric has a tensile strength of at least 20 N/5 mm.
